(19) United States
(12) Patent Application Publication
(10) Pub. No.: US 2022/0259429 A1
(43) Pub. Date: Aug. 18, 2022

(54) COMBINED USE OF POLYOL ETHERS AND CATIONIC POLYELECTROLYTES IN AQUEOUS POLYURETHANE DISPERSIONS

(71) Applicant: Evonik Operations GmbH, Essen (DE)

(72) Inventors: Michael Klostermann, Essen (DE); YeChen Le, Shanghai (CN); Kai-Oliver Feldmann, Essen (DE); Marvin Jansen, Essen (DE)

(73) Assignee: Evonik Operations GmbH, Essen (DE)

(21) Appl. No.: 17/617,127

(22) PCT Filed: Jul. 18, 2019
(86) PCT No.: PCT/CN2019/096497

§ 371 Date: Dec. 7, 2021

(51) Int. Cl. C08L 75/08; C09D 175/08

(52) U.S. Cl. CPC C08L 75/08; C08L 2205/025; C08L 2205/035; C09D 175/08

(57) ABSTRACT

The combined use of polyol ethers and cationic polyelectrolytes as additives in cosurfactant-containing aqueous polymer dispersions for production of porous polymer coatings, preferably for production of porous polyurethane coatings, is described.

### CROSS REFERENCE TO RELATED APPLICATIONS

This application is a 35 U.S.C. § 371 U.S. national phase entry of International Application No. PCT/CN2019/096497 having an international filing date of Jul. 18, 2019, which is incorporated herein by reference in its entirety.

The present invention is in the field of plastics coatings and synthetic leathers.

It relates more particularly to the production of porous polymer coatings, especially porous polyurethane coatings, by the combined use of polyol ethers and cationic polyelectrolytes as additives.

### FIELD

Textiles coated with plastics, for example synthetic leathers, generally consist of a textile carrier onto which is laminated a porous polymer layer which has in turn been coated with a top layer or a topcoat.

### BACKGROUND

The porous polymer layer in this context preferably has pores in the micrometre range and is air-permeable and hence breathable, i.e. permeable to water vapor, but water-resistant. The porous polymer layer often comprises porous polyurethane. At present, porous polyurethane layers are usually produced by a coagulation method in which DMF is used as solvent. Owing to environmental concerns, however, this production method is being increasingly criticized, and so it is to be succeeded gradually by other, more environmentally friendly technologies. One of these technologies is based on aqueous polyurethane dispersions, called PUDs. These generally consist of polyurethane microparticles dispersed in water; the solids content is usually in the range of 30-60% by weight. For production of a porous polyurethane layer, these PUDs are mechanically foamed, coated onto a carrier (layer thicknesses typically between 300-2000 μm) and then dried at elevated temperature. During this drying step, the water present in the PUD system evaporates, which results in formation of a film of the polyurethane particles. In order to further increase the mechanical strength of the film, it is additionally possible to add hydrophilic (poly)isocyanates to the PUD system during the production process, and these can react with free OH radicals present on the surface of the polyurethane particles during the drying step, thus leading to additional crosslinking of the polyurethane film.

Both the mechanical and the tactile properties of PUD coatings thus produced are determined to a crucial degree by the cell structure of the porous polyurethane film. In addition, the cell structure of the porous polyurethane film affects the air permeability and breathability of the material. Particularly good properties can be achieved here with very fine, homogeneously distributed cells. A customary way of influencing the cell structure during the above-described production process is to add foam stabilizers to the PUD system before or during the mechanical foaming. A first effect of appropriate stabilizers is that sufficient amounts of air can be beaten into the PUD system during the foaming operation. Secondly, the foam stabilizers have a direct effect on the morphology of the air bubbles produced. The stability of the air bubbles is also influenced to a crucial degree by the type of stabilizer. This is important especially during the drying of foamed PUD coatings, since it is possible in this way to prevent drying defects such as cell coarsening or drying cracks.

In the past, polyol ethers have already been identified as particularly efficient stabilizers for mechanically foamed PUD systems; see, for example, WO2019042696A1. One disadvantage of polyol ethers is, however, that the foam-stabilizing effect of this compound class can be impaired by the presence of further cosurfactants present in the PUD system, especially anionic cosurfactants. Especially in the production of aqueous polyurethane dispersions, however, the use of cosurfactants is not unusual. Cosurfactants are used in this context for improved dispersion of polyurethane prepolymers in water and generally remain in the final product. During the mechanical foaming of the polyurethane dispersion, corresponding cosurfactants can have an adverse effect on the foaming characteristics of the system, especially when polyol ethers are used for foam stabilization. As a result, it is often possible for only little air, if any at all, to be beaten into the system; the resultant foam structure is coarse and irregular. Cosurfactants can also have an adverse effect on the stability of the foams produced, which can result in foam ageing during the processing of the foamed PUD system, which in turn leads to faults and defects in the foam coatings produced.

### SUMMARY

The problem addressed by the present invention was therefore that of providing additives for production of PUD-based foam systems and foam coatings, which enable efficient foaming and efficient foam stabilization even in PUD systems containing cosurfactants, especially anionic cosurfactants.

### DETAILED DESCRIPTION

It has been found that, surprisingly, the use of polyol ethers in combination with cationic polyelectrolytes enables the solution of the stated problem.

The present invention therefore provides for the combined use of polyol ethers and cationic polyelectrolytes as additives, preferably as foam additives in aqueous polymer dispersions, preferably in aqueous polyurethane dispersions, particular preference being given to aqueous polyurethane dispersions containing cosurfactants, especially containing anionic cosurfactants.

The combined use of polyol ethers and cationic polyelectrolytes according to the invention surprisingly has manifold advantages here.

One advantage here is that the inventive joint use of polyol ethers and cationic polyelectrolytes enables efficient foaming of polyurethane dispersions, even when cosurfactants are additionally present in the dispersion system. The foams thus produced are additionally notable for an exceptionally fine pore structure with particularly homogeneous cell distribution, which in turn has a very advantageous effect on the mechanical and tactile properties of the porous polymer coatings which are produced on the basis of these foams. In addition, it is possible in this way to improve the air permeability or breathability of the coating.

A further advantage is that the inventive joint use of polyol ethers and cationic polyelectrolytes enables the production of particularly stable foams, even when cosurfactant is additionally present in the PUD system. This firstly has an advantageous effect on the processibility of the foams thus produced. Secondly, the elevated foam stability has the advantage that, during the drying of corresponding foams, drying defects such as cell coarsening or drying cracks can be avoided. Furthermore, the improved foam stability enables quicker drying of the foams, which offers processing advantages, both from an environmental and from an economic point of view.

Yet another advantage is that the inventive combinations of polyol ethers and cationic polyelectrolytes are notable for excellent hydrolysis stability over a wide pH range.

The use of polyol ethers as foam additives in aqueous polymer dispersions has already been described in detail in document WO 2019042696 A1. For the further description of the polyol ethers in the context of the present invention, this document is referred to in full.

The term “polyol ethers” over the entire scope of the present invention also includes the alkoxylated adducts thereof that can be obtained by reaction of a polyol ether with alkylene oxides, for example ethylene oxide, propylene oxide and/or butylene oxide.

The term “polyol ethers” over the entire scope of the present invention also includes polyol ester-polyol ether hybrid structures that are prepared by O-alkylation of polyol esters (with regard to the term “polyol esters” see WO2018/015260A1 in particular) or by esterification of polyol ethers.

The term “polyol ethers” over the entire scope of the present invention also includes the ionic derivatives thereof, preferably phosphorylated and sulfated derivatives, especially phosphorylated polyol ethers. These derivatives of the polyol ethers, especially phosphorylated polyol ethers, are polyol ethers usable with preference in accordance with the invention. These and other derivatives of the polyol ethers are described in detail further down, and are usable with preference in the context of the invention.

The term “cosurfactant” over the entire scope of the present invention encompasses additional surfactants that may be present in the polymer dispersion alongside the polyol ethers according to the invention. These especially include surfactants that are used during the production of the polymer dispersion. For example, polyurethane dispersions are often produced by synthesis of a PU prepolymer which is dispersed in water in a second step and then reacted with a chain extender. For improved dispersion of the prepolymer in water, it is possible here to use cosurfactants. In the context of the present invention, the cosurfactants are preferably anionic cosurfactants.

The term “cationic polyelectrolyte” over the entire scope of the present invention encompasses water-soluble polymeric compounds bearing cationic groups or basic groups that become cationic by accepting a proton. In this context, “water-soluble” means that the polymers at a temperature of 25° C. have a water solubility of at least 1% by weight, preferably of at least 5% by weight, more preferably of at least 10% by weight. A distinction should be made here between permanent polyelectrolytes that bear cationic charges irrespective of pH in aqueous solution, and weak polyelectrolytes, the charge state of which depends on the pH of the solution. Polyelectrolytes here may be homopolymers, i.e. polymers having just one repeat unit, or copolymers, i.e. polymers formed from at least two different repeat units. If polyelectrolytes are copolymers, these may have a statistical or ordered construction (as a block copolymer) or a gradient distribution.

The invention is described further and by way of example hereinafter, without any intention that the invention be restricted to these illustrative embodiments. Where ranges, general formulae or classes of compounds are specified hereinbelow, these are intended to encompass not only the corresponding ranges or groups of compounds which are explicitly mentioned but also all subranges and subgroups of compounds which can be obtained by removing individual values (ranges) or compounds. When documents are cited in the context of the present description, the contents thereof, particularly with regard to the subject matter that forms the context in which the document has been cited, are considered in their entirety to form part of the disclosure content of the present invention. Unless stated otherwise, percentages are figures in percent by weight.

When parameters which have been determined by measurement are reported below, the measurements have been carried out at a temperature of 25° C. and a pressure of 101 325 Pa, unless stated otherwise. Where chemical (empirical) formulae are used in the present invention, the specified indices may be not only absolute numbers but also average values. The indices relating to polymeric compounds are preferably average values. The structure and empirical formulae presented in the present invention are representative of all isomers feasible by differing arrangement of the repeating units.

The polyol ethers for use in accordance with the invention can especially be prepared by O-alkylation of polyols or by O-alkylation of hydroxyalkanes or hydroxyalkenes. This is known in principle and described in detail in the technical literature (see, for example, Römpp or Ullmann's Encyclopedia of Industrial Chemistry “Acylation and Alkylation” and the literature cited in each). For instance, it is known that the formation of a carbon-oxygen bond to give a corresponding polyol ether can be achieved by reacting a polyol with an alkylating agent. Alkylating agents used may be olefins, alkyl halides (Williamson ether synthesis), alcohols, ethers, epoxides, aldehydes, ketones, thiols, diazo compounds, sulfonic esters and related compounds. Typical catalysts in the case of use of olefins as alkylating agent are, for example, H₂SO₄, acidic ion exchangers, phosphoric acid and zeolites. In the Williamson ether synthesis, the alcohols or polyols are first converted to their alkoxides by reaction with, for example, sodium or potassium or sodium hydride or potassium hydride, and then reacted with an alkyl halide as alkylating agent. In the case of use of epoxides as alkylating agent, it is possible to use acids, Lewis acids, bases and Lewis bases as catalysts.

In the context of the present invention, polyol ethers usable with preference are especially those that are obtainable by the reaction of a polyol with at least one linear or branched, saturated or unsaturated, primary or secondary alcohol or corresponding mixtures. This corresponds to a preferred embodiment of the invention. Corresponding polyol ethers are known per se and are described, for example, in WO2012082157 A2.

Additionally usable with preference in the context of the present invention are especially those polyol ethers that are obtainable by the reaction of a polyol with at least one linear or branched alkyl or alkenyl halide or a linear or branched alkyl or alkenyl sulfonate, for example tosylates, mesylates, triflates or nonaflates, or mixtures of such substances. This likewise corresponds to a preferred embodiment of the invention. Corresponding polyol ethers are likewise known per se.

Additionally usable with preference in the context of the present invention are those polyol ethers that are obtainable by the reaction of a polyol with at least one linear or branched alkyl- or alkenyloxirane, -thiirane or -aziridine or mixtures of such substances. This likewise corresponds to a preferred embodiment of the invention. Corresponding polyol ethers are likewise known per se.

Additionally usable with preference in the context of the present invention are those polyol ethers that are obtainable by the reaction of a polyol with at least one linear or branched alkyl or alkenyl glycidyl ether or mixtures of such substances. This likewise corresponds to a preferred embodiment of the invention. Corresponding polyol ethers are likewise known per se.

Additionally usable with preference in the context of the present invention are those polyethers that are obtainable by the reaction of linear or branched, saturated or unsaturated, primary or secondary alcohols with glycidol or epichlorohydrin or glycerol carbonate or mixtures of these substances. This likewise corresponds to a preferred embodiment of the invention. Corresponding polyol ethers are likewise known per se.

Preferred polyols used for preparation of the polyol ethers according to the invention are selected from the group of the C₃-C₈ polyols and the oligomers and/or co-oligomers thereof. Co-oligomers result from reaction of different polyols, for example from reaction of glycerol with arabitol. Especially preferred polyols here are propane-1,3-diol, glycerol, trimethylolethane, trimethylolpropane, sorbitan, sorbitol, isosorbide, erythritol, threitol, pentaerythritol, arabitol, xylitol, ribitol, fucitol, mannitol, galactitol, iditol, inositol, volemitol and glucose. Very particular preference is given to glycerol. Preferred polyol oligomers are oligomers of C₃-C₈ polyols having 1-20, preferably 2-10 and more preferably 2.5-8 repeat units. Especially preferred here are diglycerol, triglycerol, tetraglycerol, pentaglycerol, dierythritol, trierythritol, tetraerythritol, di(trimethylolpropane), tri(trimethylolpropane) and di- and oligosaccharides. Very particular preference is given to sorbitan and oligo- and/or polyglycerols. In particular, it is possible to use mixtures of different polyols. In addition, it is also possible to use alkoxylated adducts of C3-C8 polyols, oligomers thereof and/or co-oligomers thereof for preparation of the polyethers usable in accordance with the invention, which can be obtained by reaction of C3-C8 polyols, oligomers thereof and/or co-oligomers thereof with alkylene oxides, for example ethylene oxide, propylene oxide and/or butylene oxide.

If the polyol ethers are prepared using linear or branched alkyl or alkenyl halides, preference is given here especially to those halides that conform to the general formula R—X where X is a halogen atom, preferably a chlorine atom, even more preferably a bromine atom, even more preferably an iodine atom, and where R is a linear or branched, saturated or unsaturated hydrocarbon radical having 4 to 40 carbon atoms, preferably 8 to 22, more preferably having 10 to 18 carbon atoms. Very particular preference is given here to alkyl halides selected from 1-chlorooctane, 1-chlorodecane, 1-chlorododecane, 1-chlorotetradecane, 1-chlorohexadecane, 1-chlorooctadecane, 1-chloroeicosane, 1-chlorodocosane and mixtures thereof, very particular preference being given to 1-chlorohexadecane and 1-chlorooctadecane and mixtures of these two substances.

Very particular preference is given here to alkyl halides selected from 1-bromooctane, 1-bromodecane, 1-bromododecane, 1-bromotetradecane, 1-bromohexadecane, 1-bromooctadecane, 1-bromoeicosane, 1-bromodocosane and mixtures thereof, very particular preference being given to 1-bromohexadecane and 1-bromooctadecane and mixtures of these two substances.

Very particular preference is likewise given here to alkyl halides selected from 1-iodooctane, 1-iododecane, 1-iodododecane, 1-iodotetradecane, 1-iodohexadecane, 1-iodooctadecane, 1-iodoeicosane, 1-iododocosane and mixtures thereof, very particular preference being given to 1-iodohexadecane and 1-iodooctadecane and mixtures of these two substances.

Very particular preference is likewise given here to alkyl halides selected from 2-chlorooctane, 2-chlorodecane, 2-chlorododecane, 2-chlorotetradecane, 2-chlorohexadecane, 2-chlorooctadecane, 2-chloroeicosane, 2-chlorodocosane and mixtures thereof, very particular preference being given to 2-chlorohexadecane and 2-chlorooctadecane and mixtures of these two substances.

Very particular preference is likewise given here to alkyl halides selected from 2-bromooctane, 2-bromodecane, 2-bromododecane, 2-bromotetradecane, 2-bromohexadecane, 2-bromooctadecane, 2-bromoeicosane, 2-bromodocosane and mixtures thereof, very particular preference being given to 2-bromohexadecane and 2-bromooctadecane and mixtures of these two substances.

Very particular preference is likewise given here to alkyl halides selected from 2-iodooctane, 2-iododecane, 2-iodododecane, 2-iodotetradecane, 2-iodohexadecane, 2-iodooctadecane, 2-iodoeicosane, 2-iododocosane and mixtures thereof, very particular preference being given to 2-iodohexadecane and 2-iodooctadecane and mixtures of these two substances.

If the polyol ethers are prepared using alkyl epoxides, preference is given here especially to alkyl epoxides that conform to the general formula 1

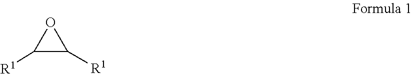

where R¹ are independently identical or different monovalent aliphatic saturated or unsaturated hydrocarbon radicals having 2 to 38 carbon atoms, preferably 6 to 20, more preferably having 8 to 18 carbon atoms, or H, with the proviso that at least one of the radicals is a hydrocarbon radical. Particular preference is given here to alkyl epoxides in which exactly one of the R¹ radicals is a hydrocarbon radical and the other is H. Very particular preference is given to epoxides that derive from C₆-C₂₄ alpha-olefins.

If the polyol ethers are prepared using alkyl glycidyl ethers, these are preferably selected from the group of the glycidyl ethers of linear or branched, saturated or unsaturated alkyl alcohols having 4 to 40 carbon atoms, preferably 8 to 22, more preferably having 10 to 18 carbon atoms.

Very particular preference is given here to alkyl glycidyl ethers selected from octyl glycidyl ether, decyl glycidyl ether, dodecyl glycidyl ether, tetradecyl glycidyl ether, hexadecyl glycidyl ether, octadecyl glycidyl ether, eicosyl glycidyl ether, docosyl glycidyl ether and mixtures thereof, very particular preference being given to hexadecyl glycidyl ether and octadecyl glycidyl ether, and mixtures of these two substances.

In a particularly preferred embodiment of the present invention, the polyol ethers are selected from the group of the sorbitan ethers and/or polyglycerol ethers. Particular preference is given to polyglycerol hexadecyl ether, polyglycerol octadecyl ether and mixtures of these two substances. Very particular preference is likewise given to polyglycerol hydroxyhexadecyl ether and polyglycerol hydroxyoctadecyl ether and mixtures of these substances. Even more preferred are polyglycerol 1-hydroxyhexadecyl ether, polyglycerol 2-hydroxyhexadecyl ether, polyglycerol 1-hydroxyoctadecyl ether and polyglycerol 2-hydroxyoctadecyl ether and mixtures of these substances.

Especially preferred here are polyglycerol ethers conforming to the general formula 2:

MₐD_{b}T_{c} Formula 2

where

M=[C₃H₅(OR²)₂O_{1/2}]

D=[C₃H₅(OR²)₁O_{2/2}]

T=[C₃H₅O_{3/2}]

a=1 to 10, preferably 2 to 3, especially preferably 2,

b=0 to 10, preferably greater than 0 to 5, especially preferably 1 to 4,

c=0 to 3, preferably 0, where the R² radicals are independently identical or different monovalent aliphatic saturated or unsaturated hydrocarbon radicals having 2 to 38 carbon atoms, preferably 6 to 20, more preferably having 8 to 18 carbon atoms, or H, with the proviso that at least one of the R² radicals is a hydrocarbon radical, which may also bear substituents, especially hydroxyl groups.

The structural elements M, D and T are joined here via oxygen bridges in each case. Two O_{1/2} radicals are always joined here to form an oxygen bridge (—O—), where any O_{1/2} radical may be joined only to one further O_{1/2} radical.

Even more preferred are polyglycerol ethers corresponding to the general formula 3:

MₓD_{y}T_{z} Formula 3

where

M=

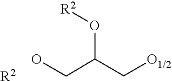

D=

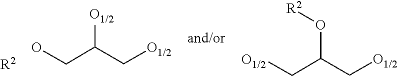

T

x=1 to 10, preferably 2 to 3, especially preferably 2,

y=0 to 10, preferably greater than 0 to 5, especially preferably 1 to 4,

z=0 to 3, preferably greater than 0 to 2, especially preferably 0,

with the proviso that at least one R² radical is not hydrogen, still R² as defined above.

Further preferred are polyglycerol ethers of the general formula 4:

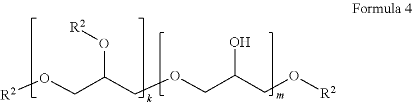

where

k=1 to 10, preferably 2 to 3, especially preferably 2,

m=0 to 10, preferably greater than 0 to 5, especially preferably 1 to 3,

with the proviso that at least one of the R² radicals is not hydrogen, still R² as defined above, and that the sum total of k+m is greater than zero and the fragments having the indices k and m are distributed statistically.

In the context of the present invention, the term “polyglycerol” is especially understood to mean a polyglycerol which may also contain glycerol. Consequently, for the purposes of calculating amounts, masses and the like, any glycerol fraction should also be taken into consideration. In the context of the present invention, polyglycerols are therefore also mixtures comprising at least one glycerol oligomer and glycerol. Glycerol oligomers should be understood in each case to mean all relevant structures, i.e., for example, linear, branched and cyclic compounds. The same applies to the term “polyglycerol ether” in connection with the present invention.

Statistical distributions are composed of blocks with any desired number of blocks and with any desired sequence, or randomized distribution; they can also have an alternating structure, or else form a gradient along the chain; in particular, they can also constitute any of the mixed forms in which groups of different distributions can optionally follow one another. Specific embodiments may lead to restrictions to the statistical distributions as a result of the embodiment. There is no change in the statistical distribution for all regions unaffected by the restriction.

Preferably, the polyglycerol ethers usable in accordance with the invention have not more than 8, more preferably not more than 6 and even further preferably not more than 5 hydrocarbon radicals of the R² form, as described above.

In structural terms, the polyol ethers can be characterized via wet-chemical indices, for example their hydroxyl number. Suitable methods for determining the hydroxyl number are particularly those according to DGF C-V 17 a (53), Ph. Eur. 2.5.3 Method A and DIN 53240. Suitable methods for determining the acid number are particularly those according to DGF C-V 2, DIN EN ISO 2114, Ph. Eur. 2.5.1, ISO 3682 and ASTM D 974. Suitable methods for determining the hydrolysis number are particularly those according to DGF C-V 3, DIN EN ISO 3681 and Ph. Eur. 2.5.6.

Suitable methods for determining the epoxy oxygen content are especially those according to R. Kaiser “Quantitative Bestimmung organischer funktioneller Gruppen Methoden der Analyse in der Chemie” [Quantitative Determination of Organic Functional Groups, Methods of Analysis in Chemistry], Akad. Verlagsgesellschaft, 1966 and R. R. Jay, Anal. Chem. 1964, 36 (3), 667-668.

Suitable methods for determining the melting point are especially those according to DIN 53181, DIN EN ISO 3416, DGF C-IV 3a and Ph.Eur.2.2.14.

It is preferable in accordance with the invention and corresponds to a particularly preferred embodiment of the invention when, for preparation of the polyglycerol ether, a polyglycerol having an average degree of condensation of 1-20, preferably of 2-10 and more preferably of 2.5-8 is used. The average degree of condensation N can be determined here on the basis of the OH number (OHN, in mg KOH/g) of the polyglycerol and is linked thereto according to:

$$N = \frac{112200 - 18 \cdot OHN}{75 \cdot OHN - 56100}$$

The OH number of the polyglycerol can be determined here as described above. Consequently, preferred polyglycerols for preparation of the polyglycerol ethers according to the invention are especially those which have an OH number of 1829 to 824, more preferably of 1352-888 and especially preferably of 1244-920 mg KOH/g.

The usable polyglycerol can be provided here by different conventional methods, for example polymerization of glycidol (e.g. base-catalysed), polymerization of epichlorohydrin (for example in the presence of a base such as NaOH) or polycondensation of glycerol. According to the invention, preference is given to the provision of the polyglycerol by the condensation of glycerol, especially in the presence of catalytic amounts of a base, especially NaOH or KOH.

Suitable reaction conditions are temperatures between 200 and 260° C. and reduced pressure in a range between 20 and 800 mbar, especially between 50 and 500 mbar, which enables easier removal of water. Moreover, various commercial polyglycerols are obtainable, for example from Solvay, Innovyn, Daicel and Spiga Nord S.p.A.

It has already been made clear that the term “polyol ethers” over the entire scope of the present invention also encompasses the ionic derivatives thereof, preferably the phosphorylated and sulfated derivatives, especially phosphorylated polyol ethers. Phosphorylated polyol ethers are obtainable here by reaction of the polyol ethers with a phosphorylating reagent and optional, preferably obligatory, subsequent neutralization (cf. especially Industrial Applications of Surfactants. II. Preparation and Industrial Applications of Phosphate Esters. Edited by D. R. Karsa, Royal Society of Chemistry, Cambridge, 1990). Preferred phosphorylating reagents in the context of this invention are phosphorus oxychloride, phosphorus pentoxide (P4010) and more preferably polyphosphoric acid. The term “phosphorylated polyol ethers” over the entire scope of the present invention also covers the partly phosphorylated polyol ethers, and the term “sulfated polyol ethers” over the entire scope of the present invention likewise also covers the partly sulfated polyol ethers.

In addition, ionic derivatives of the polyol ethers over the entire scope of the present invention can also be obtained by reaction of the polyethers with di- or tricarboxylic acid or corresponding cyclic anhydrides and optional, preferably obligatory, neutralization.

In addition, ionic derivatives of the polyol ethers over the entire scope of the present invention can also be obtained by reaction of the polyethers with unsaturated di- or tricarboxylic acid or corresponding cyclic anhydrides and subsequent sulfonation and optional, preferably obligatory, neutralization.

The term “neutralization” over the entire scope of the present invention also covers partial neutralization. For neutralization, including partial neutralization, it is possible to use customary bases. These include the water-soluble metal hydroxides, for example barium hydroxide, strontium hydroxide, calcium hydroxide, thallium(I) hydroxide and preferably the hydroxides of the alkali metals that dissociate into free metal and hydroxide ions in aqueous solutions, especially NaOH and KOH. These also include the anhydro bases which react with water to form hydroxide ions, for example barium oxide, strontium oxide, calcium oxide, lithium oxide, silver oxide and ammonia. As well as these aforementioned alkalis, solid substances usable as bases are also those which likewise give an alkaline reaction on dissolution in water without having HO— (in the solid compound); examples of these include amines such as mono-, di- and trialkylamines, which may also be functionalized alkyl radicals as, for example, in the case of amide amines, mono-, di- and trialkanolamines, mono-, di- and triaminoalkylamines, and, for example, the salts of weak acids, such as potassium cyanide, potassium carbonate, sodium carbonate, trisodium phosphate, etc.

Very particularly preferred polyol ethers in the context of this invention here are phosphorylated sorbitan ethers and/or phosphorylated polyglycerol ethers, in particular phosphorylated polyglycerol ethers. Especially preferred are a phosphorylated and neutralized polyglycerol hexadecyl ether, a phosphorylated and neutralized polyglycerol octadecyl ether or a mixture of these substances.

A particularly preferred embodiment of this invention envisages the use in accordance with the invention of polyol ethers of the formula 2, 3 and/or 4, as specified above, with the additional proviso that they have been (at least partly) phosphorylated, such that these polyol ethers of the formula 2, 3 and/or 4 especially bear at least one (R³O)₂P(O)— radical as the R² radical, where the R³ radicals are independently cations, preferably Na⁺, K⁺ or NH₄⁺, or ammonium ions of mono-, di- and trialkylamines, which may also be functionalized alkyl radicals as, for example, in the case of amide amines, of mono-, di- and trialkanolamines, of mono-, di- and triaminoalkylamines, or H or R⁴—O—,

where R⁴ is a monovalent aliphatic saturated or unsaturated hydrocarbon radical having 3 to 39 carbon atoms, preferably 7 to 22 and more preferably having 9 to 18 carbon atoms or a polyol radical.

In the case of the sulfated polyol ethers, preference is given especially to those obtainable by reaction of the polyol ethers with sulfur trioxide or amidosulfonic acid. Preference is given here to sulfated sorbitan ethers and/or sulfated polyglycerol ethers.

In the context of the present invention, it is particularly preferable when the cationic polyelectrolytes used in combination with polyol ethers are polyethyleneimine, and condensation products thereof, peptides and polyamides containing arginine and/or histidine, amine- and guanidine-functional siloxanes and (co)polymers of allylamine, diallylamine, alkyl derivatives and quaternization products thereof, especially diallyldimethylammonium chloride, vinylamine, divinylamine, vinylpyridine and quaternization products thereof, vinylimidazole, alkyl derivatives and quaternization products thereof, esters of ethylenically unsaturated carboxylic acids with amino alcohols, amides of ethylenically unsaturated carboxylic acids with N,N-dialkylaminoalkylamines and mixtures of these substances. Very particular preference is given here to (co)polymers based on vinylamine.

In the context of the present invention, it is also particularly preferred when the cationic polyelectrolytes are polymers having at least one repeat unit A of the formula 4

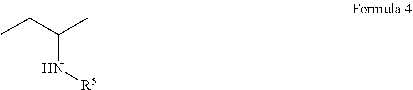

and optionally at least one repeat unit B of the formula 5

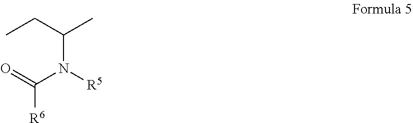

where the R⁵ and R⁶ radicals are independently identical or different monovalent aliphatic or aromatic, saturated or unsaturated hydrocarbon radicals having 1 to 10 carbon atoms, preferably 1 to 10, more preferably having 1 to 5 carbon atoms or H, more preferably H.

It is preferable here in accordance with the invention when the repeat units A are present in the polymer to an extent of at least 50 mol %, preferably to an extent of at least 60 mol %, more preferably to an extent of at least 70 mol %, even more preferably to an extent of at least 80 mol %, even more preferably to an extent of at least 90 mol %, most preferably to an extent of 100 mol %.

The polymers of the repeat units A and B that are preferred in accordance with the invention can be prepared by free-radical polymerization of N-vinylcarboxamides and subsequent complete or partial hydrolysis of the amide function to amine functions. The hydrolysis can be effected here under acidic or alkaline conditions. Preferred N-vinylcarboxamides here are N-vinylformamide, N-vinyl-N-methylformamide, N-vinyl-N-ethylformamide, N-vinyl-N-propylformamide, N-vinyl-N-isopropylformamide, N-vinyl-N-butylformamide, N-vinyl-N-isobutylformamide, N-vinylacetamide, N-vinyl-N-methylacetamide, N-vinyl-N-ethylacetamide, N-vinyl-N-propylacetamide, N-vinyl-N-isopropylacetamide, N-vinyl-N-butylacetamide, N-vinyl-N-isobutylacetamide, N-vinylpropionamide, N-vinylmethylpropionamide, N-vinyl-N-ethylpropionamide, N-vinyl-N-propylpropionamide, and mixtures of these substances, preference being given especially to N-vinylformamide.

Further monoethylenically unsaturated comonomers or comonomer mixtures may optionally have been incorporated into the polymers preferred in accordance with the invention as well as the repeat units A and B, in order thus to arrive at further-modified polymers. These may be nonionic, cationic or anionic monomers. Preferred nonionic comonomers here are unsaturated alcohols, such as vinyl alcohol or allyl alcohol, and alkoxylates thereof, unsaturated nitriles, aliphatic or aromatic olefins, N-vinyllactams, for example N-vinylpyrrolidone or N-vinylcaprolactam, vinyl esters of organic carboxylic acids, esters of monoethylenically unsaturated carboxylic acids, and amides of monoethylenically unsaturated carboxylic acids. Preferred cationic comonomers are vinylimidazole and monomers containing vinylimidazole units, alkyl derivatives and quaternization products thereof, vinylpyridines and quaternization products thereof, basic esters of ethylenically unsaturated carboxylic acids with amino alcohols, and basic amides of ethylenically unsaturated carboxylic acids with N,N-dialkylaminoalkylamines. Preferred anionic comonomers are □□□-unsaturated monocarboxylic acids, unsaturated dicarboxylic acids and/or partial esters of unsaturated dicarboxylic acids.

In the case of comonomer-containing polymers, it is preferable here when the comonomers are used in a concentration of 0.1-50 mol %, preferably of 0.5-25 mol %, more preferably of 1-15 mol %, based on the overall composition of the polymer.

In the context of the present invention, especially preferred cationic polyelectrolytes are those that have an average molar mass of 1000-500 000 g/mol, preferably of 5000-250 000 g/mol, more preferably of 10 000-100 000 g/mol. The molar mass of the polyelectrolytes can be determined here by methods known to the person skilled in the art, such as preferably gel permeation chromatography (GPC).

In the case of cationic polyelectrolytes having a pH-dependent degree of dissociation, it is additionally a preferred embodiment of the present invention when the degree of dissociation of these compounds, and hence their cationic character, is adjusted by addition of acids, for example hydrochloric acid, lactic acid, citric acid or sulfuric acid.

As already described, the present invention envisages the combined use of polyol ethers and cationic polyelectrolytes as described above as additives in aqueous polymer dispersions, preferably in aqueous polyurethane dispersions. The polymer dispersions here are preferably selected from the group of aqueous polystyrene dispersions, polybutadiene dispersions, poly(meth)acrylate dispersions, polyvinyl ester dispersions and polyurethane dispersions. The solids content of these dispersions is preferably in the range of 20-70% by weight, more preferably in the range of 25-65% by weight. Particular preference is given in accordance with the invention to the use of polyol ethers and cationic polyelectrolytes as additives in aqueous polyurethane dispersions, especially in cosurfactant-containing aqueous polyurethane dispersions. Especially preferable here are polyurethane dispersions based on polyester polyols, polyester amide polyols, polycarbonate polyols, polyacetal polyols and polyether polyols.

In the context of the present invention, it is preferable when the total amount of polyol ethers and cationic polyelectrolytes, based on the total weight of the aqueous polymer dispersion, is in the range of 0.2-20% by weight, more preferably in the range of 0.4-15% by weight, especially preferably in the range of 0.5-10% by weight.

It is additionally preferred when cationic polyelectrolytes are used in an amount of 2.5-80% by weight, preferably of 5-75% by weight, more preferably of 7.5-50% by weight, based on the overall mixture of polyol ether and cationic polyelectrolytes.

Preferably, the inventive combinations of polyol ethers and cationic polyelectrolytes are used in aqueous polymer dispersions as foaming aids or foam stabilizers for foaming of the dispersions. In addition, however, they can also be used as drying aids, levelling additives, wetting agents and rheology additives.

As well as the inventive combination of polyol ethers and cationic polyelectrolytes, the aqueous polymer dispersions may also comprise further additions such as color pigments, fillers, flatting agents, stabilizers such as hydrolysis or UV stabilizers, antioxidants, absorbers, crosslinkers, levelling additives, thickeners and further cosurfactants.

Polyol ether and cationic polyelectrolytes can be added to the aqueous dispersion either in pure or blended form in a suitable solvent. In this case, it is possible to blend the two components beforehand in a solvent or separately in two different solvents. It is also possible to blend just one of the two components in a suitable solvent beforehand, while the other component is added in pure form to the aqueous dispersion. Preferred solvents in this connection are selected from water, propylene glycol, dipropylene glycol, polypropylene glycol, butyldiglycol, butyltriglycol, ethylene glycol, diethylene glycol, polyethylene glycol, polyalkylene glycols based on EO, PO, BO and/or SO, and mixtures of these substances, very particular preference being given to aqueous dilutions or blends. Blends or dilutions of polyol ethers and/or cationic polyelectrolytes preferably contain additive concentrations of 10-80% by weight, more preferably 15-70% by weight, even more preferably 20-60% by weight.

In the case of aqueous dilutions or blends of polyol ethers and/or cationic polyelectrolytes, it may be advantageous when hydrotropic compounds are added to the blend to improve the formulation properties (viscosity, homogeneity, etc.). Hydrotropic compounds here are water-soluble organic compounds consisting of a hydrophilic part and a hydrophobic part, but are too low in molecular weight to have surfactant properties. They lead to an improvement in the solubility or in the solubility properties of organic, especially hydrophobic organic, substances in aqueous formulations. The term “hydrotropic compounds” is known to those skilled in the art. Preferred hydrotropic compounds in the context of the present invention are alkali metal and ammonium toluenesulfonates, alkali metal and ammonium xylenesulfonates, alkali metal and ammonium naphthalenesulfonates, alkali metal and ammonium cumenesulfonates, and phenol alkoxylates, especially phenol ethoxylates, having up to 6 alkoxylate units. To improve formulation properties, blends of polyol ether and/or cationic polyelectrolytes may also likewise contain additional cosurfactants. Cosurfactants preferred in accordance with the invention, in this connection, are, for example, fatty acid amides, ethylene oxide-propylene oxide block copolymers, betaines, for example amidopropyl betaines, amine oxides, quaternary ammonium surfactant, ammonium amphoacetate and/or alkali metal salts of fatty acid, alkyl sulfates, alkyl ether sulfates, alkyl sulfonates, alkylbenzenesulfonates, alkyl phosphates, alkyl sulfosuccinates, alkyl sulfosuccinamates and alkyl sarcosinates. In addition, the cosurfactant may comprise silicone-based surfactants, for example trisiloxane surfactants or polyether siloxanes. In the case of ammonium and/or alkali metal salts of fatty acids, it is preferable when they contain less than 25% by weight of stearate salts, and are especially free of stearate salts.

Since, as described above, the combined use of polyol ethers and cationic polyelectrolytes leads to a distinct improvement in porous polymer coatings produced from aqueous polymer dispersions, especially in the case of cosurfactant-containing polymer dispersions, the present invention likewise provides aqueous polymer dispersions comprising at least one of the polyol ethers according to the invention and at least one of the cationic polyelectrolytes according to the invention, as described in detail above.

The present invention also provides porous polymer layers produced from aqueous polymer dispersions, preferably cosurfactant-containing aqueous polymer dispersions, obtained by the inventive combined use of polyol ethers and cationic polyelectrolytes, as described in detail above.

Preferably, the porous polymer coatings according to the invention can be produced by a process comprising the steps of
a) providing a mixture comprising at least one aqueous polymer dispersion, at least one of the polyol ethers according to the invention, at least one of the cationic polyelectrolytes according to the invention and optionally further additives,
b) foaming the mixture to give a homogeneous, fine-cell foam,
c) optionally adding at least one thickener to adjust the viscosity of the wet foam, d) applying a coating of the foamed polymer dispersion to a suitable carrier,
e) drying/curing the coating.

With a view to preferred configurations, especially with a view to the polyol ethers, cationic polyelectrolytes and polymer dispersions that are usable with preference in the process, reference is made to the preceding description and also to the aforementioned preferred embodiments, especially as detailed in the claims.

It is made clear that the process steps of the process according to the invention as set out above are not subject to any fixed sequence in time. For example, process step c) can be executed at an early stage, at the same time as process step a).

It is a preferred embodiment of the present invention when, in process step b), the aqueous polymer dispersion is foamed by the application of high shear forces. The foaming can be effected here with the aid of shear units familiar to the person skilled in the art, for example Dispermats, dissolvers, Hansa mixers or Oakes mixers.

In addition, it is preferable when the wet foam produced at the end of process step c) has a viscosity of at least 5, preferably of at least 10, more preferably of at least 15 and even more preferably of at least 20 Pa·s, but of not more than 500 Pa·s, preferably of not more than 300 Pa·s, more preferably of not more than 200 Pa·s and even more preferably of not more than 100 Pa·s. The viscosity of the foam can be determined here preferably with the aid of a Brookfield viscometer, LVTD model, equipped with an LV-4 spindle. Corresponding test methods for determination of the wet foam viscosity are known to those skilled in the art.

As already described above, additional thickeners can be added to the system to adjust the wet foam viscosity.

Preferably, the thickeners which can be used advantageously in the context of the invention are selected here from the class of the associative thickeners. Associative thickeners here are substances which lead to a thickening effect through association at the surfaces of the particles present in the polymer dispersions. The term is known to those skilled in the art. Preferred associative thickeners are selected from polyurethane thickeners, hydrophobically modified polyacrylate thickeners, hydrophobically modified polyether thickeners and hydrophobically modified cellulose ethers. Very particular preference is given to polyurethane thickeners. In addition, it is preferable in the context of the present invention when the concentration of the thickeners based on the overall composition of the dispersion is in the range of 0.01-10% by weight, more preferably in the range of 0.05-5% by weight, most preferably in the range of 0.1-3% by weight.

In the context of the present invention, it is additionally preferable when, in process step d), coatings of the foamed polymer dispersion with a layer thickness of 10-10 000 μm, preferably of 50-5000 μm, more preferably of 75-3000 μm, even more preferably of 100-2500 μm, are produced. Coatings of the foamed polymer dispersion can be produced by methods familiar to the person skilled in the art, for example knife coating. It is possible here to use either direct or indirect coating processes (called transfer coating).

It is also preferable in the context of the present invention when, in process step e), the drying of the foamed and coated polymer dispersion is effected at elevated temperatures. Preference is given here in accordance with the invention to drying temperatures of min. 50° C., preferably of 60° C., more preferably of at least 70° C. In addition, it is possible to dry the foamed and coated polymer dispersions in multiple stages at different temperatures, in order to avoid the occurrence of drying defects. Corresponding drying techniques are widespread in industry and are known to those skilled in the art.

As already described, process steps c)-e) can be effected with the aid of widely practised methods known to those skilled in the art. An overview of these is given, for example, in “Coated and laminated Textiles” (Walter Fung, CR-Press, 2002).

In the context of the present invention, preference is given especially to those porous polymer coatings comprising polyol ethers and cationic polyelectrolytes and having an average cell size less than 350 μm, preferably less than 200 μm, especially preferably less than 150 μm, most preferably less than 100 μm. The average cell size can preferably be determined by microscopy, preferably by electron microscopy. For this purpose, a cross section of the porous polymer coating is viewed by means of a microscope with sufficient magnification and the size of at least 25 cells is ascertained. In order to obtain sufficient statistics for this evaluation method, the magnification of the microscope should preferably be chosen such that at least 10×10 cells are present in the observation field. The average cell size is then calculated as the arithmetic average of the cells or cell sizes viewed. This determination of cell size by means of a microscope is familiar to the person skilled in the art.

The inventive porous polymer layers (or polymer coatings) comprising polyol ethers, cationic polyelectrolytes and optionally further additives can be used, for example, in the textile industry, for example for synthetic leather materials, in the building and construction industry, in the electronics industry, for example for foamed seals, in the sports industry, for example for production of sports mats, or in the automotive industry.

### EXAMPLES

Substances:

SYNTEGRA® YS 3000: MDI (methyl diphenyl diisocyanate)-based polyurethane dispersion from DOW. As a result of the process for preparing it, the product contains 1-3% by weight of the anionic cosurfactant sodium dodecylbenzenesulfonate (CAS: 25155-30-0).

Lupasol® 4570: vinylamine-vinylformamide copolymer (molar ratio 70:30) of moderate molecular weight from BASF. 31% by weight in water.

Lupasol® FG 1904: multifunctional cationic polyethyleneimines having branched structure from BASF.

ORTEGOL® PV 301: polyurethane-based associative thickener from Evonik Nutrition & Care GmbH.

Viscosity Measurements:

All viscosity measurements were conducted with a Brookfield viscometer, LVTD model, equipped with an LV-4 spindle, at a constant rotation speed of 12 rpm. For the viscosity measurements, the samples were transferred into a 100 ml jar into which the measurement spindle was immersed. The display of a constant viscometer measurement was always awaited.

### Example 1: Blending of a Polyol Ether Surfactant

The surfactant was blended using a polyglycerol hydroxystearyl ether that was prepared as follows: A mixture of commercially available polyglycerol-3 (Spiga Nord, hydroxyl number 1124 mg KOH/g, 52.5 g, 0.219 mol, 1.0 equiv.) and sodium methoxide (1.96 g of a 25% solution in methanol, 0.009 mol, 0.04 equiv.) was heated to 180° C. while stirring and introducing N2 at 15 mbar within 2 h and the methanol was distilled off After 180° C. had been attained, the vacuum was broken and then 1,2-epoxyoctadecane that had been heated to 80° C. (CAS RN 7390-81-0, 85%, 97.0 g, 0.361 mol, 1.65 equiv.) was slowly added dropwise over the course of 1 h. The mixture was stirred at 180° C. for a further 4 h until an epoxy oxygen content of 0.16% had been attained. Subsequently, the mixture was cooled down to 90° C. and the phases were separated. This gave 5.6 g of unconverted polyglycerol (lower phase) and 113 g of polyglyceryl hydroxyalkyl ether (upper phase, melting point=71.5° C., hydroxyl number=387 mg KOH/g, acid number=0.4 mg KOH/g, epoxy oxygen content=0.06%).

24 g of this polyol ether were blended with 6.3 g of propylene glycol and 69.7 g of water and homogenized at 80° C.

### Example 2: Foaming Experiments

To test the efficacy of the additive combination according to the invention, a series of foaming experiments was conducted. For this purpose, the SYNTEGRA® YS 3000 polyurethane dispersion from DOW was used. This contains between 1% and 3% by weight of sodium dodecylbenzenesulfonate (CAS: 25155-30-0) as anionic cosurfactant. The foam stabilizer used was the surfactant blend described in Example 1. The cationic polyelectrolytes used were the two substances Lupasol® FG 1904 and Lupasol® 4570. Table 1 gives an overview of the compositions of the respective experiments. In experiments #1 to #3, only the polyol ether surfactant or only a cationic polyelectrolyte was used as additive; these experiments served as comparative experiments in order to show the effect of the individual components. In experiments #4 and #5, by contrast, inventive combinations of polyol ether surfactant and a cationic polyelectrolyte were used to demonstrate the improved effect of these additive combinations.

All foaming experiments were conducted manually. For this purpose, polyurethane dispersion, surfactant and cationic polyelectrolyte were first placed in a 500 ml plastic cup and homogenized with a dissolver equipped with a dispersing disc (diameter=6 cm) at 1000 rpm for 3 min. For foaming of the mixtures, the shear rate was then increased to 2000 rpm, ensuring that the dissolver disc was always immersed into the dispersion to a sufficient degree that a proper vortex formed. At this speed, the mixtures were foamed to a volume of about 350 ml. Subsequently, the Ortegol® PV 301 thickener was added gradually to the foam formulation with the aid of a syringe and the mixture was sheared at 1000 rpm for a further 15 minutes. In this step, the dissolver disc was immersed sufficiently deeply into the mixtures that no further air was introduced into the system, but the complete volume was still in motion.

TABLE 1
Overview of foam formulations

| | #1 | 2 | 3 | #4 | 5 |
|---|---|---|---|---|---|
| SYNTEGRA ^{®} YS 3000 | 150 | 150 | 150 | 150 | 150 |
| Polyol ether surfactant | 6 | — | — | 6 | 6 |
| Lupasol ^{®} 4570 | — | 1 | — | 1 | — |
| Lupasol ^{®} FG 1904 | — | — | 1 | — | 1 |
| Ortegol ^{®} PV 301 | 0.5 | 0.5 | 0.5 | 0.5 | 0.5 |
| Wet foam viscosity [mPa s] | 4400 | >500000 | >500000 | 14500 | 14000 |

In the case of the foam that contained only the polyol ether surfactant (experiment #1), quite a coarse and inhomogeneous foam was obtained at the end of the foaming operation. When this foam was stored in a closed vessel over a period of 30 min, further coarsening of the foam structure was observed. It was also noticeable that the viscosity of the foam was quite low and hence it had a mobile consistency (the viscosities of the foams are likewise noted in Table 1). In the case of foams that contained only a cationic polyelectrolyte (experiments #2 and #3), the mixtures could be foamed without any problem to a volume of 350 ml, but a decline in the foam volume to about 250 ml was observed a few minutes after the foaming. The viscosity of the mixtures rose so significantly here that they were barely still stirrable. On storage of the sample over a period of 30 minutes, a further rise in viscosity was observed. In the case of the experiments that were conducted with the inventive additive combination of polyol ether surfactant and cationic polyelectrolyte (experiments #4 and #5), homogeneous foams with fine cells were obtained at the end of the foaming operation, and these coarsened only slightly in the course of storage for 30 min.

The foams were then knife-coated onto a textile carrier (layer thickness ˜800 μm) with the aid of a Labcoater LTE-S laboratory spreading table/dryer from Mathis AG and then dried at 60° C. for 5 min and at 120° C. for a further 5 min. It was noticeable here that foams that contained only a polyol ether surfactant (experiment #1) coarsened further during the drying operation, and so the textile coatings produced showed quite a coarse-cell and inhomogeneous foam structure. The effect of this was that corresponding samples had less appealing tactile properties as well as a visually poor appearance. In the case of coatings that contained only a cationic polyelectrolyte (experiments #2 and #3), as a result of the distinct rise in viscosity immediately after foaming, it was possible only with difficulty to knife-coat the foam onto the textile carrier. This results in defect sites and irregularities in the foam coating. This, and also the fact that only a lightly foamed compact mass was knife-coated, had the additional effect that corresponding samples felt very hard and rigid and had less appealing tactile properties. By contrast, it was possible to knife-coat foams that contained the inventive additive combination of polyol ether and cationic polyelectrolyte (experiments #4 and #5) in a defect-free manner. After drying, no noticeable coarsening of the foam structure was observed, such that defect-free and fine-cell foam coatings that featured not only a homogeneous appearance but also good tactile properties were obtained. These experiments thus clearly show the improved effect of the additive combination according to the invention.

1. A dispersion comprising a dispersion additive comprising a combination of polyol esters and cationic polyelectrolytes, wherein the dispersion is selected from the group consisting of aqueous polymer dispersions, aqueous polyurethane dispersions, and aqueous polyurethane dispersions containing anionic cosurfactants.

2. The dispersion according to claim 1, wherein the polyol ethers are obtained by the reaction of a polyol with at least one alkyl or alkylene halide, at least one primary or secondary alcohol, at least one alkyl- or alkenyloxirane, -thiirane or -aziridine, or else at least one alkyl or alkenyl glycidyl ether, or obtained by the reaction of primary or secondary alcohols with glycidol, epichlorohydrin and/or glycerol carbonate.

3. The dispersion according to claim 2, wherein the polyols are selected from the group of the C₃-C₈ polyols and oligomers thereof.

4. The dispersion according to claim 2, wherein the alkyl halide conforms to the general formula R—X where X is a halogen atom, and where R is a linear or branched, saturated or unsaturated hydrocarbon radical having 4 to 40 carbon atoms.

5. The dispersion according to claim 2, wherein the alkyl epoxide conforms to the general formula 1: 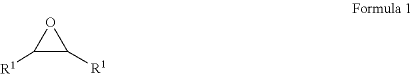
where R¹ are independently identical or different monovalent aliphatic saturated or unsaturated hydrocarbon radicals having 2 to 38 carbon atoms, wherein at least one of the radicals is a hydrocarbon radical.

6. The dispersion according to claim 2, wherein the alkyl glycidyl ethers are selected from the group consisting of the glycidyl ethers of linear or branched, saturated or unsaturated alkyl alcohols having 4 to 40 carbon atoms.

7. The dispersion according to claim 1, wherein the polyol ethers used include those that are selected from the group of the sorbitan ethers and/or polyglycerol ethers.

8. The dispersion according to claim 1, wherein the polyol ethers of the formula 2, 3 and/or 4 have been phosphorylated, bear at least one (R³O)2P(O)— radical as the R² radical, where the R³ radicals are independently cations, preferably Na+, K+ or NH4+, or ammonium ions of mono-, di- and trialkylamines, which may also be functionalized alkyl radicals as, in the case of amide amines, of mono-, di- and trialkanolamines, of mono-, di- and triaminoalkylamines, or H or R⁴—O—,
where R⁴ is a monovalent aliphatic saturated or unsaturated hydrocarbon radical having 3 to 39 carbon atoms.

9. The dispersion according to claim 1, wherein the cationic polyelectrolytes are selected from the group consisting of polyethyleneimine, and condensation products thereof, peptides and polyamides containing arginine and/or histidine, amine- and guanidine-functional siloxanes and (co)polymers of allylamine, diallylamine, alkyl derivatives and quaternization products thereof, especially diallyldimethylammonium chloride, vinylamine, divinylamine, vinylpyridine and quaternization products thereof, vinylimidazole, alkyl derivatives and quaternization products thereof, esters of ethylenically unsaturated carboxylic acids with amino alcohols, amides of ethylenically unsaturated carboxylic acids with N,N-dialkylaminoalkylamines and/or mixtures of these substances.

10. The dispersion according to claim 1, wherein the cationic polyelectrolytes are polymers having at least one repeat unit A of the formula 4 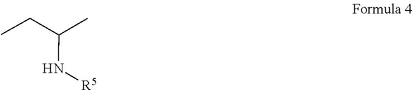
and optionally at least one repeat unit B of the formula 5 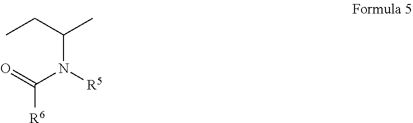
where the R⁵ and R⁶ radicals are independently identical or different monovalent aliphatic or aromatic, saturated or unsaturated hydrocarbon radicals having 1 to 10 carbon atoms,
when the repeat units A are present in the polymer to an extent of at least 50 mol %.

11. The dispersion according to claim 9, wherein the polymers can be prepared from the repeat units A and B by free-radical polymerization of N-vinylcarboxamides and subsequent full or partial hydrolysis of the amide function to amine functions.

12. The dispersion according to claim 9, wherein further monoethylenically unsaturated comonomers or comonomer mixtures have been incorporated into the polymers as well as the repeat units A and B, where these are nonionic, preferably unsaturated alcohols such as vinyl alcohol or allyl alcohol, and alkoxylates thereof, unsaturated nitriles, aliphatic or aromatic olefins, N-vinyllactams, for example N-vinylpyrrolidone or N-vinylcaprolactam, vinyl esters of organic carboxylic acids, esters of monoethylenically unsaturated carboxylic acids and amides of monoethylenically unsaturated carboxylic acids, cationic monomers preferably containing vinylimidazole and vinylimidazoline units, alkyl derivatives and quaternization products thereof, vinylpyridines and quaternization products thereof, basic esters of ethylenically unsaturated carboxylic acids with amino alcohols and basic amides of ethylenically unsaturated carboxylic acids with N,N-dialkylaminoalkylamines, and anionic.

13. The dispersion according to claim 1, wherein the aqueous polymer dispersions are selected from the group consisting of aqueous polystyrene dispersions, polybutadiene dispersions, poly(meth)acrylate dispersions, polyvinyl ester dispersions and polyurethane dispersions, and where the solids content of these dispersions is in the range of from 20-70% by weight based on the overall dispersion.

14. The dispersion according to claim 1, wherein the total amount of polyol ethers and cationic polyelectrolytes based on the total weight of the aqueous polymer dispersion is in the range of 0.2-20% by weight.

15. The use according to claim 1, wherein cationic polyelectrolytes are used in a concentration of 2.5-80% by weight, based on the overall mixture of polyol ether and cationic polyelectrolytes.

16. An aqeous polymer dispersion comprising polyol ethers and cationic polyelectrolytes, preferably as described in claim 1.

17. A process for producing a porous polymer coating by the combined use of polyol ethers and cationic polyelectrolytes as additives in aqueous polymer dispersions, comprising the steps of
a) providing a mixture comprising at least one aqueous polymer dispersion, preferably aqueous polyurethane dispersion, especially aqueous cosurfactant-containing polyurethane dispersion, at least one polyol ether, at least one cationic polyelectrolyte and optionally further additives,
b) foaming the mixture to give a homogeneous, fine-cell foam,
c) optionally adding at least one thickener to adjust the viscosity of the wet foam,
d) applying a coating of the foamed polymer dispersion to a suitable carrier,
e) drying the coating.

18. The porous polymer coating, obtained by the combined use of polyol ethers and cationic polyelectrolytes as additives in aqueous polymer dispersions, obtained by a process according to claim 17,
wherein the porous polymer coating has an average cell size less than 150 μm.

19. The dispersion according to claim 2, wherein the polyols are selected from the group of propane-1,3-diol, glycerol, trimethylolethane, trimethylolpropane, sorbitan, sorbitol, isosorbide, erythritol, threitol, pentaerythritol, arabitol, xylitol, ribitol, fucitol, mannitol, galactitol, iditol, inositol, volemitol and glucose,
and the polyol oligomers are selected from the group consisting of diglycerol, triglycerol, tetraglycerol, pentaglycerol, dierythritol, trierythritol, tetraerythritol, di(trimethylolpropane), tri(trimethylolpropane) and di- and oligosaccharides.

20. The dispersion according to claim 2, wherein the alkyl halide are selected from the group consisting of 1-chlorohexadecane, 1-chlorooctadecane, 2-chlorohexadecane, 2-chlorooctadecane, 1-bromohexadecane, 1-bromooctadecane, 2-bromohexadecane, 2-bromooctadecane, 1-iodohexadecane, 1-iodooctadecane, 2-iodohexadecane and 2-iodooctadecane.
